(19) United States
(12) Patent Application Publication
(10) Pub. No.: US 2009/0217257 A1
(43) Pub. Date: Aug. 27, 2009

(54) Apparatus and Method for Firmware Update

(75) Inventors: Ming Hong Huang, Hsinchu Hsien (TW); Chao Ping Su, Hsinchu Hsien (TW); Chih Chieh Lee, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MStar Semiconductor, Inc., Hsinchu Hsien (TW)

(21) Appl. No.: 12/392,284

(22) Filed: Feb. 25, 2009

(30) Foreign Application Priority Data
Feb. 27, 2008 (TW) 097106731

(51) Int. Cl. G06F 9/44; G06F 12/00; G06F 12/02

(52) U.S. Cl. 717/168; 711/103; 711/E12.001; 711/E12.008

(57) ABSTRACT

An apparatus and a method for firmware update to provide reliable firmware update for electronic devices, thereby improving user convenience. A firmware update apparatus includes a first storage unit, a second storage unit, a checking unit and a controller. The first and second storage units store first and second firmware codes of an electronic device, respectively. The checking unit checks whether the second firmware code is valid. The microcontroller initiates the checking unit upon start of the electronic device, and determines whether to execute the second firmware code upon determining the validity of the second firmware code.

### CROSS REFERENCE TO RELATED PATENT APPLICATION

This patent application is based on Taiwan, R.O.C. patent application No. 097106731 filed Feb. 27, 2008.

### FIELD OF THE INVENTION

The present invention relates to firmware of an electronic device, and more particularly, to an apparatus and a method for firmware update in an electronic device.

### BACKGROUND OF THE INVENTION

Firmware containing code to be executed for operations of many electronic devices is generally stored in a specific storage device in an electronic device. Latest-version code for firmware update are provided by manufacturers to solve operation complications of the electronic device, to modify hardware settings of the electronic device, or even to offer new functions.

During firmware update in a common electronic device, a newer version code of the firmware is written into the specific storage device to replace an older version code. However, in the event a back copy of the older version code of the firmware is not maintained and the newer version code has improper contents, e.g., errors resulting from the writing in process, operation difficulties or even malfunctions may result, causing user inconvenience.

### SUMMARY OF THE INVENTION

Therefore, an objective of the present invention is to provide an apparatus and a method for firmware update offering reliable firmware update for electronic devices, thereby improving user convenience. An embodiment of the invention provides an apparatus for firmware update for use in an electronic device. The apparatus comprises: a first storage unit for storing a first firmware code of the electronic device; a second storage unit for storing a second firmware code of the electronic device; a checking unit, coupled to the second storage unit, for checking whether the second firmware code is valid; and a controller, for initiating the checking unit and determining whether to execute the second firmware code upon validity of the second firmware code.

An embodiment of the invention further provides a method for firmware update for use in an electronic device, in which a first firmware code of the electronic device is stored in a first storage unit of the electronic device and a second firmware code of the electronic device is stored in a second storage unit. The method comprises steps of: executing the first firmware code, upon start of the electronic device, to initiate a validity check on the second firmware code; executing the validity check to determine whether the second firmware code in the second storage device is valid; and determining whether to execute the second firmware code in the second storage device according to an outcome of the validity check.

### BRIEF DESCRIPTION OF THE DRAWINGS

The present invention will become more readily apparent to those ordinarily skilled in the art after reviewing the following detailed description and accompanying drawings, in which:

FIG. 1 is a block diagram of an apparatus for firmware update according to a preferred embodiment of the invention.

FIG. 2 is a flowchart of a method for firmware update according to a preferred embodiment of the invention.

### DETAILED DESCRIPTION OF THE PREFERRED EMBODIMENT

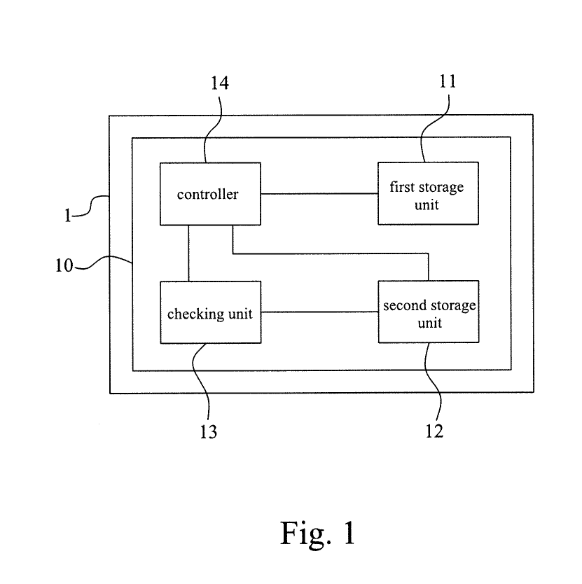

FIG. 1 shows a block diagram of an apparatus for firmware update according to a preferred embodiment of the invention. The firmware update apparatus 10 is implemented in an electronic device 1, and comprises a first storage unit 11, a second storage unit 12, a checking unit 13 and a controller 14. The electronic device 1 may be a display device such as a monitor, a television, or a digital photo frame. The first storage unit 11 is loaded with an existing firmware code of the electronic device 1. The second storage unit 12 is loaded with an updated firmware code of the electronic device 1. That is, firmware codes of different versions are stored in different storage units, respectively. The first storage unit 11 and the second storage unit 12 may be a flash memory or an electrically erasable programmable read-only memory (EEPROM). The checking unit 13 is coupled to the second storage unit 12, and checks whether the updated code stored in the second storage unit 12 is valid. Checking methods used by the checking unit 13 are not limited by the invention, and thus do not affect the scope of the invention. In a preferred embodiment, the checking unit 13 executes a cyclic redundancy check (CRC) to determine whether the updated firmware code is valid. In another preferred embodiment, the checking unit 13 executes a checksum to determine whether the updated firmware code is valid. The controller 14 is coupled to the first storage unit 11, the second storage unit 12 and the checking unit 13, and executes the existing firmware code or updated firmware code to control operations of the electronic device 1.

In the preferred embodiment shown in FIG. 1, the existing firmware code is a reliable version of the firmware written into the first storage unit 11 before the exit-factory date to ensure the electronic device 1 functions normally, and is not modified after that. After the exit-factory date of the electronic device 1, any updated firmware code of a newer version is written into the second storage device 12, and its validity is checked by the checking unit 13, followed by the controller determining whether to execute the update firmware code according to an outcome of the validity check. The invention does not impose restrictions on how the updated firmware code is written into the second storage unit 12, and thus the scope of the invention should be understood to encompass various methodologies for accomplishing this task.

An operation procedure of the firmware update device 10 shall be described below. Upon start or restart of the electronic device 1, the controller 14 first executes the existing firmware code in the first storage unit 11. A beginning portion of the existing firmware code commands the controller 14 to initiate the checking unit 13 to check whether the second storage unit 12 is loaded with a valid updated firmware code. The checking unit 13 then checks and responds to the controller 14 with an outcome of the checking. When the outcome indicates that the second storage unit 12 is not loaded with a valid updated firmware code, the controller 14 continues to execute the existing firmware code and ignores the second storage unit 12. When the outcome indicates that the second storage unit 12 is loaded with a valid updated firmware code, the controller 14 starts to execute the updated firmware code to control operations of the electronic device 1 instead of executing the existing firmware code.

To be more precise, each time the electronic device 1 starts or restarts, the controller 14 first executes a portion of the existing firmware code, such as a beginning portion, so as to initiate checking the updated firmware code in the second storage unit 12. When the second storage unit 12 is loaded with a valid updated firmware code, the controller 14 starts to execute the updated firmware code instead of the existing firmware code. When the second storage unit 12 is not loaded with a valid updated firmware code, the controller 14 continues to execute the existing firmware code. It is to be noted that the existing firmware code is a reliable version that ensures normal operations of the electronic device 1. Therefore, by implementing the foregoing operation procedure of the firmware update device 10, availability of a valid updated firmware code is checked while a reliable existing firmware code may still be used when a valid updated firmware code is found unavailable due to a failure in updating the firmware, so as to maintain normal operations of the electronic device 1. Compared with the prior art, the firmware update device 10 provides a more dependable firmware update method.

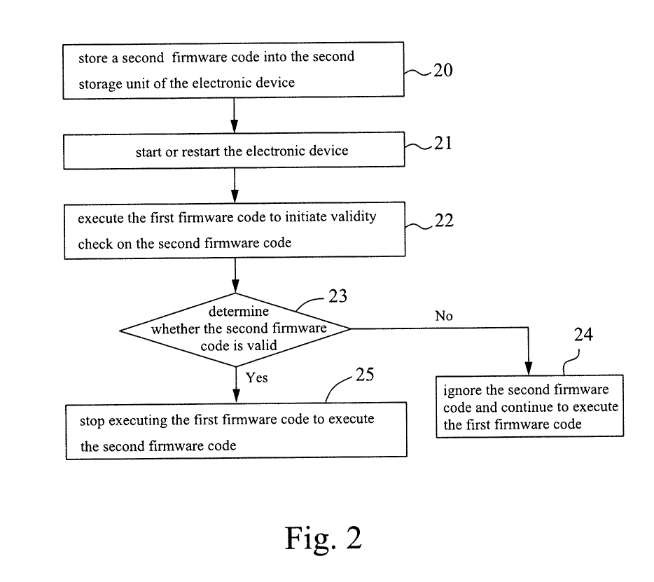

FIG. 2 shows a flowchart of a method for firmware update according to an embodiment of the invention. The method for firmware update is implemented in an electronic device such as a display device including a monitor, a television, or a digital photo frame. The electronic device comprises a first storage unit and a second storage unit for storing firmware codes of different versions, respectively. The first storing unit is for storing the first firmware code. Referring to FIG. 2, the method for firmware update comprises the following steps. In Step 20, storing a second firmware code in the second storage unit of the electronic device is performed. In Step 21, starting or restarting the electronic device is performed. In Step 22, executing the first firmware code to initiate validity check on the second firmware code in the second storage unit is performed. In Step 23, executing the validity check to determine whether the second firmware code in the second storage unit is valid is performed. Then, skip to Step 25 if the second firmware code is valid or continue to Step 24 if the second firmware code is not valid. In Step 24, ignoring the second firmware code and continuing to execute the first firmware code are performed. In Step 25, stopping executing the first firmware code to execute the second firmware code is performed.

In Step 23, the validity check is performed using a CRC or a checksum calculation to determine whether the second firmware code is valid. In one embodiment, Step 22 executes a portion of the first firmware code to initiate the validity check on the second firmware code in the second storage unit.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An apparatus for firmware update, for use in an electronic device, comprising:
a first storage unit, for storing a first firmware code of the electronic device;
a second storage unit, for storing a second firmware code of the electronic device;
a checking unit, coupled to the second storage unit, for checking whether the second firmware code is valid; and
a controller, for initiating the checking unit, and determining whether to execute the second firmware code based on validity of the second firmware code.

2. The apparatus for firmware update as claimed in claim 1, wherein the first firmware code is an existing code, and the second firmware code is an updated code.

3. The apparatus for firmware update as claimed in claim 1, wherein the controller executes the first firmware code to initiate the checking unit.

4. The apparatus for firmware update as claimed in claim 3, wherein the controller continues in executing the first firmware code instead of starting to execute the second firmware code when the second firmware code is invalid.

5. The apparatus for firmware update as claimed in claim 3, wherein the controller stops executing the first firmware code and starts to execute the second firmware code when the second firmware code is valid.

6. The apparatus for firmware update as claimed in claim 1, wherein the first storage unit is a flash memory or an electrically erasable programmable read-only memory (EEPROM).

7. The apparatus for firmware update as claimed in claim 1, wherein the second storage unit is a flash memory or an EEPROM.

8. The apparatus for firmware update as claimed in claim 1, wherein the checking unit performs a cyclic redundancy check (CRC) to determine the validity of the second firmware code.

9. The apparatus for firmware update as claimed in claim 1, wherein the checking unit performs a checksum calculation to determine the validity of the second firmware code.

10. The apparatus for firmware update as claimed in claim 1, wherein the electronic device is a display device.

11. The apparatus for firmware update as claimed in claim 10, wherein the display device is a monitor, a television or a digital photo frame.

12. A method for firmware update, for use in an electronic device, a first firmware code of the electronic device being stored in a first storage unit and a second firmware code of the electronic device being stored in a second storage unit, the method comprising steps of:
executing the first firmware code, upon start of the electronic device, to initiate a validity check on the second firmware code;
executing the validity check to determine whether the second firmware code is valid; and
determining whether to execute the second firmware code according to an outcome of the validity check.

13. The method for firmware update as claimed in claim 12, wherein execution of the first firmware code is continued instead of executing the second firmware code when the second firmware code is invalid.

14. The method for firmware update as claimed in claim 12, wherein execution of the first firmware code is stopped to start execution of the second firmware code when the second firmware code is valid.

15. The method for firmware update as claimed in claim 12, wherein the validity check is implemented using a cyclic redundancy check (CRC) to determine the validity of the second firmware code.

16. The method for firmware update as claimed in claim 12, wherein the validity check is implemented using a checksum calculation to determine the validity of the second firmware code.

17. The method for firmware update as claimed in claim 12, wherein the electronic device is a display device.

18. The method for firmware update as claimed in claim 17, wherein the display device is a monitor, a television, or a digital photo frame.
